(19) United States
(12) Patent Application Publication
(10) Pub. No.: US 2016/0131285 A1
(43) Pub. Date: May 12, 2016

(54) PIPING JOINT STRUCTURE

(71) Applicant: TOYOTA JIDOSHA KABUSHIKI KAISHA, Toyota-shi (JP)

(72) Inventors: Kenji KOMIYA, Nagoya-shi (JP); Masaaki KONDO, Owariasahi-shi (JP); Akira YAMASHITA, Toyota-shi (JP); Shusuke INAGI, Toyota-shi (JP); Hidetsugu HAYASHI, Toyota-shi (JP)

(73) Assignee: TOYOTA JIDOSHA KABUSHIKI KAISHA, Toyota-shi (JP)

(21) Appl. No.: 14/930,971

(22) Filed: Nov. 3, 2015

(30) Foreign Application Priority Data
Nov. 12, 2014 (JP) 2014-229863

(51) Int. Cl. F16L 19/06; F16L 15/08

(52) U.S. Cl. CPC F16L 19/06; F16L 15/08

(57) ABSTRACT

An object is to prevent a reduction in an inner diameter of a front end portion of a pipe to be connected, and thereby prevent an increase in a pressure loss, even when a larger axial force is secured. A piping joint structure is provided, which includes a pipe, where a first flow path for a fluid is formed therein, having an opening of the first flow path, and having a first sealing surface on an outer surface thereof; a connector where a second flow path is formed therein, having an opening of the second flow path, having a second sealing surface in an inner surface thereof, and having a male threaded portion in an outer surface thereof; and a nut having a female threaded portion to be screwed to the male threaded portion, the female threaded portion of the nut is screwed to the male threaded portion of the connector in a state that the first sealing surface of the pipe is in contact with the second sealing surface of the connector, so that the pipe is connected with the connector. In a side section of the piping joint structure including an axis of the second flow path, a male threaded portion area where the male threaded portion is away in an axial direction of the second flow path from a seal area where the first sealing surface is in contact with the second sealing surface.

### CROSS REFERENCE TO RELATED APPLICATION

This application claims priority to Japanese Patent Application No. 2014-229863, filed on Nov. 12, 2014, the contents of all of which are incorporated herein by reference in their entirety.

### BACKGROUND

1. Field

The present invention relates to a piping joint structure.

2. Related Art

FIG. 2 is a cross-sectional view schematically illustrating a piping joint structure 100 as one example of joint structures for high-pressure piping which is conventionally known. This piping joint structure is similar to the one disclosed in JP1998-185052A. The piping joint structure 100 includes a connector 120 where a flow path 123 is formed therein, a pipe 130 where a flow path 133 is formed, and a nut 140 for connecting the connector 120 to the pipe 130. In a vicinity of one end of the connector 120 where an opening of the flow path 123 is formed, the connector 120 has a concave portion 124 where a diameter of the flow path 123 gradually increases toward the end and a wall forming the flow path 123 becomes gradually thinner toward the end, even though an outer diameter of the wall forming the flow path 123 is approximately constant. Further, a male threaded portion 121 is formed on an outer surface of the connector 120 near the opening of the flow path 123. The pipe 130 has a convex portion 132 formed near one of ends of the flow path 133 where openings of the flow path 133 are formed. An outer diameter of the convex portion 132 is formed larger than other portions thereof. The convex portion 132 has the flow path 133 of which a diameter of a cross section is approximately constant; however, the outer diameter of the convex portion 132 is gradually reduced toward the front end or the end where the opening of the flow path 133 is formed. The nut 140 has an engagement portion 142 which engages with the convex portion 132 of the pipe 130, and a female threaded portion 141 which threadedly engages with the male threaded portion 121 of the connector 120.

Assembling of the piping joint structure 100 is performed, in a state where an inner surface of the concave portion 124 formed at the one end of the connector 120 is in contact with an outer surface of the convex portion 132 formed in the one end of the pipe 130, by threadedly engaging the nut 140 with an outer surface of the connector 120 after the convex portion 132 of the pipe 130 is engaged with the engagement portion 142 of the nut 140. Thus, a sealing between the flow path 123 of the connector 120 and the flow path 133 of the pipe 130 is secured by the surface contact between the inner surface of the concave portion 124 of the one end of the connector 120 and the outer surface of the convex portion 132 of the one end of the pipe 130.

This kind, of piping joint structure for high-pressure fluid is, for example, used in piping for filling up a reservoir tank with fluid, such as gas, at a high pressure. Generally, in the piping joint structure for high-pressure fluid, it is necessary to sufficiently tighten the nut against the connector in order to obtain an axial force which can secure the sealing of the joint structure over a long period of time. Therefore, the male threaded portion 121 is formed over the entire area of the outer surface of the connector 120, which overlaps with the inner surface of the nut 140, and a large fastening torque is applied to the nut 140 in order to secure the sufficient axial force.

However, when the fastening torque is increased in the piping joint structure 100 to increase the axial force acting on the connector 120, an external force which radially acts from the connector 120 inwardly of the flow path 133 on the pipe 130 may become excessive at the one end side of the pipe 130, the diameter of the one end of the flow path 133 may be reduced. The reduction in the diameter of the flow path 133 causes an increase in passage resistance of the piping joint structure 100. For example, when the piping joint structure for high-pressure fluid is used for a flow path for filling the fluid, the increase in passage resistance of the piping joint structure causes a reduction in filling rate.

### SUMMARY

The present invention is made in order to address the subjects described above, and can be implemented in terms of the following aspects.

According to one aspect of the invention, a piping joint structure is provided. The piping joint structure comprises: a pipe that is configured to provide a first flow path for a fluid therein and to have an opening of the first flow path at a first end portion thereof and a first sealing surface on an outer surface thereof at the first end portion side; a connector that is connected with the pipe, wherein the connector is configured to provide a second flow path connecting with the first flow path therein and to have an opening of the second flow path at a second end portion thereof, a second sealing surface on a inner surface thereof at the second end portion side that is in contact with the first sealing surface, and a male threaded portion on an outer surface thereof at the second end portion side; and a nut having a female threaded portion in an inner surface thereof to be screwed to the male threaded portion, the female threaded portion of the nut is screwed to the male threaded portion of the connector in a state that the first sealing surface of the pipe is in contact with the second sealing surface of the connector, so that the pipe is connected with the connector. In a side section of the piping joint structure including an axis of the second flow path, a male threaded portion area where the male threaded portion is formed is away in an axial direction of the second flow path from a seal area where the first sealing surface is in contact with the second sealing surface.

According to the piping joint structure of this aspect, even when the nut is attached to the connector with a fastening torque by which a large axial force is obtained, the radially inward pressing force of the connector against the pipe can be prevented from becoming excessive, thereby preventing a radially inward deformation of the pipe (a reduction in the diameter). As a result, an increase in a pressure loss in the piping joint structure resulting from the diameter reduction of the pipe can be prevented.

The present invention can be implemented in any various forms other than described above, such as a connector used in the piping joint structure, a fluid filling device provided with the piping joint structure, and a movable body provided with a hydrogen tank and a piping for filling up the hydrogen tank with hydrogen, to which the piping joint structure is provided, as well as a fuel cell used as a driving source.

### BRIEF DESCRIPTION OF THE DRAWINGS

FIG. 1 is a cross-sectional view schematically illustrating a structure of a piping joint structure; and

FIG. 2 is a cross-sectional view schematically illustrating a structure of a piping joint structure.

### DESCRIPTION OF THE EMBODIMENTS

### A. Entire Configuration of Piping Joint Structure

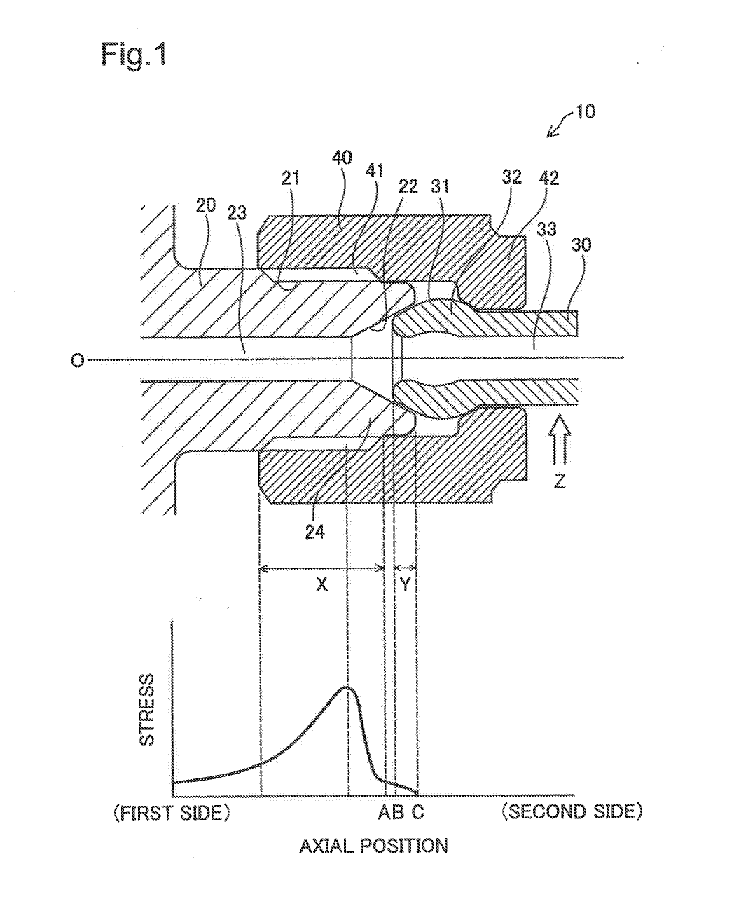

FIG. 1 is a cross-sectional view schematically illustrating a piping joint structure 10 as one embodiment according to the present invention. The piping joint structure 10 includes a connector 20 where a flow path 23 is formed therein, a pipe 30 where a flow path 33 is formed, and a nut 40 for connecting the connector 20 to the pipe 30. In this embodiment, the flow path 33 corresponds to a “first flow path” in SUMMARY, and the flow path 23 corresponds to a “second flow path.” in SUMMARY

In this embodiment, the piping joint structure 10 is used for connecting pipings for filling up high-pressure hydrogen. Specifically, the piping joint structure 10 is used for connecting pipings of a flow path for filling up a hydrogen tank with hydrogen in a fuel cell vehicle provided with a fuel cell as a driving source and the hydrogen tank for storing the hydrogen as fuel to be supplied to the fuel cell.

FIG. 1 illustrates an axial center of the flow path 23 formed in the connector 20 as a center axis O. FIG. 1 is a side section of the piping joint structure 10, including the center axis O. An axial center of the flow path 33 is mostly in agreement with the center axis O near a portion of the pipe 30 where the nut 40 is attached and connected to the connector 20. In the following description, a direction parallel to the center axis O is referred to as “axial direction,” and a side on which the connector 20 is disposed in the axial direction is referred to as a “first side,” and a side on which the pipe 30 is disposed in the axial direction is referred to as a “second side.”

The connector 20 has a concave portion 24 formed near the second end thereof where an opening of the flow path 23 is formed. The concave portion 24 has a cylindrical wall where the flow path 23 is formed therein. The cylindrical wall has an outer diameter which is approximately constant; however, has an inner diameter thereof forming the flow path 23 gradually increases toward the second side end and the wall thickness becomes gradually thinner toward the second side end. In this embodiment, the second side of the connector 20 in the axial direction is also referred to as a “front end side.” A male threaded portion 21 is formed on an outer surface of the connector 20, near the opening on the front end side of the flow path 23. In this embodiment, an end portion on the front end side of the connector 20 corresponds to a “second end portion” in SUMMARY.

The pipe 30 has a convex portion 32 formed near an end on the first side where an opening of the flow path 33 is formed. The convex portion 32 has a cylindrical wall where the flow path 33 is formed therein. The cylindrical wall has an outer diameter which is larger than other portions. The cylindrical wall has an inner diameter forming the flow path 33 which is approximately constant; however, an outer diameter thereof is gradually reduced toward the end on the first side. In this embodiment, the first side of the pipe 30 in the axial direction is also referred to as a “front end side.” In this embodiment, an end portion on the front end side of the pipe 30 corresponds to a “first end portion” in SUMMARY

The nut 40 is in an approximately cylindrical shape having an axial center located on the center axis O, and has an engagement portion 42 formed in the second side end in the axial direction. The engagement portion 42 has an inner wall surface protruding toward the center axis O to engage with the convex portion 32 of the pipe 30. Further, the nut 40 has a female threaded portion 41 in an inner wall surface on the first side in the axial direction, and the female threaded portion 41 threadedly engages with the male threaded portion 21 of the connector 20.

An inner surface of the concave portion 24 of the connector 20 forms a second sealing surface 22. An outer surface of a portion of the convex portion 32 of the pipe 30, of which a diameter is reduced toward the front end side forms a first sealing surface 31. In the piping joint structure 10, the flow path 23 and the flow path 33 are sealed by mutually contact between the second sealing surface 22 and first sealing surface 31.

Assembling of the piping joint structure 10 is carried out, in a state where the second sealing surface 22 which is the inner surface of the concave portion 24 of the connector 20 is in contact with the first sealing surface 31 which is the outer surface of the convex portion 32 of the pipe 30, by engaging the convex portion 32 of the pipe 30 with the engagement portion 42 of the nut 40 and then threadedly engaging the nut 40 with the connector 20. Thus, a sufficient fastening force (axial force) can be produced in the piping joint structure 10 to secure the sealing between the flow path 23 and the flow path 33 by a surface contact between the second sealing surface 22 and the first sealing surface 31.

In this embodiment, the connector 20, the pipe 30, and the nut 40 are made of for example, austenite stainless steel, such as SUS316L. The austenite stainless steel has a higher tolerance against hydrogen embrittlement compared with other ferrous metals, such as other stainless steels and carbon steels and, thus, it is particularly suitable as material for hydrogen pipings. Since the nut 40 is a member which does not directly come into contact with hydrogen, it may be made of materials other than the austenite stainless steel. When the nut 40 is made of material having a different oxidizing speed from the connector 20 and the pipe 30 (i.e., made of material which is lower or higher in iodization tendency than the connector 20 and the pipe 30), corrosions of the connector 20 and the pipe 30, or a corrosion of the nut 40 is stimulated, respectively, thereby causing a possible reduction in the durability of the entire piping joint structure 10. Therefore, the connector 20, the pipe 30, and the nut 40 are desirably made of the same metallic material. When the hydrogen embrittlement tolerance is within a predetermined allowable range, the members may be made of stainless steel other than the austenite stainless steel, and other alloys, such as carbon steel, and may be coated, if needed.

### B. Structure of Piping Connection

In the piping joint structure 10 of this embodiment, the position of the second side end of the male threaded portion 21 (front end side of the connector 20) provided on the connector 20 is away from the second side end of the connector 20 (front most position of the connector 20) in the axial direction toward the first side (rear end side of the connector 20). In FIG. 1, the position of the end of the male threaded portion 21 on the front end side in the axial direction is indicated as a position A, and the front most position of the connector 20 is indicated as a position C.

Further, in the piping joint structure 10 of this embodiment, the first side end of the pipe 30 (front most position of the pipe 30) is away from the position A of the second side end of the male threaded portion 21 (front end side of the connector 20) provided on the connector 20 in the axial direction toward the second side. In FIG. 1, the front most position of the pipe 30 is indicated as a position B.

In the side section of FIG. 1, a male threaded portion area where the male threaded portion 21 is formed on the connector 20 is projected in the direction perpendicular to the axial direction and is indicated as an area X. Further, in FIG. 1, a seal area where the second sealing surface 22 is in contact with the first sealing surface 31 is projected in the direction perpendicular to the axial direction and is indicated as an area Y. As illustrated in FIG. 1, the area X and the area Y are away from each other in this embodiment.

FIG. 1 also schematically illustrates a distribution in the axial direction of a stress applied in the radial direction in the connector 20 by the fastening force (axial force) of the nut 40 in the piping joint structure 10. As illustrated in FIG. 1, it is generally known that, upon the threadedly engagement or fastening, a most, very large load is received (i.e., the stress becomes the maximum) by thread crests of the male threaded portion 21 closest to the end, on the nut inserting side (the second side in the axial direction), i.e., one to several thread crests from the second side end in the axial direction. In other words, the stress applied in the radial direction generated in the connector 20 gradually increases from the first side (rear end side) toward the second side (front end side) in the axial direction, and it presents a peak in a thread crest close to the second side end of the male threaded portion 21. The magnitude of the stress in the connector 20 decreases abruptly on the front end side of the position where the stress reaches its peak. The stress becomes extremely smaller than the peak on the further front side of the second side end of the male threaded portion 21.

In the piping joint structure 10, when the nut 40 is fastened, the connector 20, which is in contact with the pipe 30 within the seal area Y described already, applies a radially inward force (toward the center axis O) to the pipe 30. Thus, the second sealing surface 22 and the first sealing surface 31 are closely in contact with each other, thereby achieving the sealing between the second sealing surface 22 and the first sealing surface 31. The pressing force of the second sealing surface 22 against the first sealing surface 31 increases as the stress in the radial direction in the connector 20 becomes larger.

As described already, in this embodiment, the position A of the second side end of the male threaded portion 21 in the axial direction (front end of the male threaded portion 21) is located on the first side of the position B of the first side end of the pipe 30 in the axial direction (front end of the pipe 30). Thus, the radially inward force applied from the connector 20 to the pipe 30 (a force corresponding to the stress produced within a range of the position B to the position C in the axial direction) becomes very small compared with the peak stress obtained according to the fastening force (axial force). Although the stress produced in the part where the second sealing surface 22 comes into contact with the first sealing surface 31 is very small compared with the peak stress, a sufficient sealing property is secured in this embodiment by a design of the shape of the convex portion 32 at the front end of the pipe 30 and the shape of the concave portion 24 at the front end of the connector 20.

According to the piping joint structure 10 of this embodiment constructed as described above, the section in which the male threaded portion 21 of the connector 20 is formed is away from the section in which the pipe 30 is disposed by the predetermined distance in the axial direction, in the side section including the center axis O of the flow path 23. Thus, even when the nut 40 is attached to the connector 20 with a large fastening torque, the radially inward pressing force of the connector 20 against the pipe 30 can be prevented from becoming excessive, thereby preventing a radially inward deformation of the pipe 30 (a reduction in the diameter). As a result, an increase in a pressure loss in the piping joint structure 10 resulting from the diameter reduction of the pipe 30 can be prevented. Therefore, a reduction in a filling rate when filling up the hydrogen tank with hydrogen at high pressure due to the increase in the pressure loss can be prevented, and a lengthening in a filling time when filling up the hydrogen tank with hydrogen can be prevented.

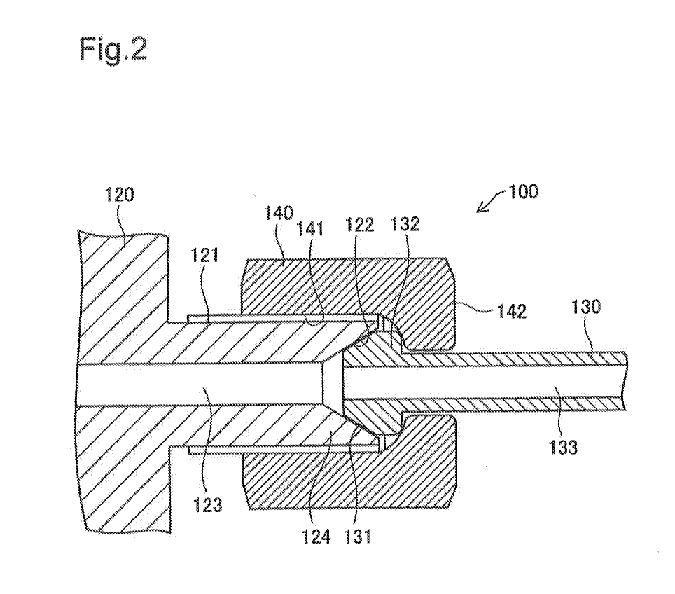

On the other hand, for example, as illustrated in FIG. 2, when the male threaded portion of the connector is formed entirely over the area where the connector overlaps with the nut, and the male threaded portion of the connector overlaps with the pipe when they are projected in the direction perpendicular to the axial direction, the connector presses the pipe radially inwardly at a position of the connector where a stress becomes a peak or a nearby position. In such a case, a force corresponding to a very large fastening force (axial force) which is produced by fastening is applied to the pipe, and the pipe is reduced in diameter. According to this embodiment, such an inconvenience can be prevented.

As described already, in this embodiment, the piping joint structure 10 is used in the piping through which hydrogen flows, and the pipe 30 is made of austenite stainless steel. Since the austenite stainless steel has a lower hardness than other ferrous metals, such as stainless steel, the pipe 30 is easy to be reduced in the diameter when the radially inward force is applied. In this embodiment, since the radially inward force applied from the connector 20 to the pipe 30 can be prevented as described above, the effect of preventing the increase in the pressure loss due to the diameter reduction of the pipe 30 can notably be obtained when the piping joint structure 10 is applied to the hydrogen piping and the pipe 30 is made of austenite stainless steel.

Further, in this embodiment, even when the peak stress obtained, according to the fastening force (axial force) is large as described above, the radially inward force applied from the connector 20 to the pipe 30 can be prevented. Thus, even when the fastening torque is increased in order to obtain a larger axial force, the diameter reduction of the pipe 30 can be prevented. When influences of temperature, vibration, and corrosion in conditions where the piping joint structure 10 is used are considered, it is necessary to obtain a very large axial force when assembling the piping joint structure 10 in order to secure the sealing of piping over a long period of time. In other words, the piping joint structure 10 is necessary to be configured to be applicable to temperature conditions, for example, when hydrogen is rapidly filled up at about −40° C., or when temperature of vehicle components exceeds 100° C. by using the fuel cell vehicle under a high temperature environment. Further, the piping joint structure 10 is always influenced by vibration when the vehicle travels. Further, a corrosion advances in the constituent members of the piping joint structure 10 with a long term use. Since the axial force in the piping joint structure 10 becomes gradually weaker by these influences, it is necessary to secure a larger axial force in advance when assembling the piping joint structure 10 in order to secure the sealing of the piping over the long period of time. In the piping joint structure 10 of this embodiment, the reliability of the sealing of the piping can be improved by fastening with a larger axial force while preventing the diameter reduction of the pipe 30.

Although it is necessary to have a sufficient stress produced in the part where the second sealing surface 22 is in contact with the first sealing surface 31 in this embodiment in order to secure the sealing of the piping, the required stress can easily be secured in the sealing surfaces described above by designing the axial force when fastening the nut 40, specifically, the fastening torque to be sufficiently large. Thus, when the fastening torque is designed in order to obtain the required axial force, it is not necessary to strictly manage the fastening torque in order to secure the required stress in the sealing surfaces described above, and thereby, and a management of the fastening operation can be made easier in the manufacturing process.

Further, in this embodiment, an effect of preventing noise which is produced in the piping can be obtained by preventing the diameter reduction of the pipe 30. In other words, when the pipe 30 is reduced in the diameter, a turbulence occurs due to a choke of the fluid flow, and thereby a flow sound (noise) may be produced due to the turbulence. When such a flow sound is transmitted into a vehicle cabin through the piping, a vehicle operator and/or passenger(s) may feel uncomfortableness and/or fear. In this embodiment, such an inconvenience can be prevented by preventing the diameter reduction of the pipe 30.

Further, according to the piping joint structure 10 of this embodiment, even when a large load is applied to a base of the pipe 30, the reduction in the sealing property in the piping joint structure 10 can be prevented. In other words, in this embodiment, the concave portion 24 is formed in the front end portion of the connector 20, the portion of the connector 20 which is in contact with the front end portion of the pipe 30 (first sealing surface 31) does not overlap with the male threaded portion 21 when it is projected in the direction perpendicular to the axial direction, and the portion having the wall thickness thinner than other portions (hereinafter, also referred to as a “thin-wall portion”). The portion of the connector 20 having the second sealing surface 22 is not fixed by the nut 40 and is thus movable in the state that the portion is in contact with the front end of the pipe 30 and maintains the sealing property. Even when a large external force is applied to the base of the pipe 30, the front end of the pipe 30 moving integrally with the thin-wall portion at the end of the connector 20 releases the external force.

In FIG. 1, a white arrow Z indicates the external force applied to the base of the pipe 30. Since the pipe 30 is an elastic member, the external force can be released by moving the pipe 30 itself, even when the external force is applied. However, when the external force is applied to the base of the pipe 30, i.e., near the connecting area between the pipe 30 and the nut 40, the external force cannot be released by the movement of the pipe 30 because the pipe 30 is fixed by the nut 40. For example, when the male threaded portion 21 is formed up to the front end of the connector 20 and the front end portion of the connector 20 is entirely fixed by the nut 40, the external force cannot be released when the external force is applied to the base of the pipe 30 by integrally moving the front end portion of the pipe 30 with the thin-wall portion at the front end of the connector 20. Thus, when the thin-wall portion of the connector 20 is fixed, only the front end portion of the pipe 30 moves to release the external force, thereby the sealing position of the second sealing surface 22 and the first sealing surface 31 may be deviated to reduce the sealing property. According to this embodiment, since the thin-wall portion is provided which is movable integrally with the front end of the pipe 30, such an inconvenience can be prevented.

In this embodiment, the front end of the male threaded portion 21 is referred to as a position of a valley or root of the thread which is formed on the front end side of the thread crest located closest to the front end of the male threaded portion 21.

### C. Modifications

### Modification 1

Although the first sealing surface 31 is formed in the area including the front end of the pipe 30 in the embodiment described above, different structures may also be adopted. For example, a structure which does not come into contact with the connector 20, does not receive the pressing force from the connector 20, and does not contribute to the diameter reduction due to the pressing force from the connector 20 may be further formed in a front end portion of the pipe 30, on a further front end side of the portion where the first sealing surface 31 is formed. Even in such a case, similar effects of the embodiment described above can also be obtained, when the male threaded portion area X of the connector 20 where the male threaded portion 21 is formed and the seal area Y where the second sealing surface 22 is in contact with the first sealing surface 31 satisfy the spatial relationship described already.

### Modification 2

Although the piping joint structure 10 is attached to the piping for filling up hydrogen in the fuel cell vehicle in the embodiment described above, different structures may also be adopted. For example, the piping joint structure 10 is also applicable to various devices provided with the hydrogen tank inside thereof, as well as movable bodies other than vehicles. Further, similar piping joint structures to the embodiment described above may also be applied to pipings through which fluid other than hydrogen flows.

The invention is not limited to any of the embodiment, the examples and the modifications described above but may be implemented by a diversity of other configurations without departing from the scope of the invention. For example, the technical features of any of the embodiment, examples and modifications corresponding to the technical features of each of the aspects described in SUMMARY may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A piping joint structure, comprising:
a pipe that is configured to provide a first flow path for a fluid therein and to have an opening of the first flow path at a first end portion thereof and a first sealing surface on an outer surface thereof at the first end portion side;
a connector that is connected with the pipe, wherein the connector is configured to provide a second flow path connecting with the first flow path therein and to have an opening of the second flow path at a second end portion thereof, a second sealing surface on a inner surface thereof at the second end portion side that is in contact with the first sealing surface, and a male threaded portion on an outer surface thereof at the second end portion side; and
a nut having a female threaded portion in an inner surface thereof to be screwed to the male threaded portion, the female threaded portion of the nut is screwed to the male threaded portion of the connector in a state that the first sealing surface of the pipe is in contact with the second sealing surface of the connector, so that the pipe is connected with the connector, wherein
in a side section of the piping joint structure including an axis of the second flow path, a male threaded portion area where the male threaded portion is formed is away in an axial direction of the second flow path from a seal area where the first sealing surface is in contact with the second sealing surface.
